(19) United States
(12) Patent Application Publication
(10) Pub. No.: US 2026/0241946 A1
(43) Pub. Date: Aug. 20, 2026

(54) VEHICLE DRIVING SYSTEM

(71) Applicants: Hyundai Motor Company, Seoul (KR); Kia Corporation, Seoul (KR)

(72) Inventor: Han Shik Kim, Hwaseong-si (KR)

(21) Appl. No.: 19/408,217

(22) Filed: Dec. 3, 2025

(30) Foreign Application Priority Data
Feb. 17, 2025 (KR) 10-2025-0020194

(51) Int. Cl. B60W 50/08; B60W 40/08; B60W 50/14

(52) U.S. Cl. CPC B60W 50/087; B60W 40/08; B60W 50/14; B60W 2040/0863; B60W 2520/10; B60W 2540/10; B60W 2540/215; B60W 2552/05; B60W 2555/60; B60W 2720/30

(57) ABSTRACT

A vehicle driving system and methods of use are provided. The system may comprise a vehicle accelerator pedal, an accelerator pedal sensor configured to measure a degree of pressure applied to the accelerator pedal, and a computing device comprising a processor and a memory configured to store instructions that, when executed by the processor, are configured to cause the processor to determine whether there is an abnormal vehicle operation based on the degree of pressure on the accelerator pedal, determine whether the accelerator pedal is misidentified based on information about a road currently being driven on and a current speed of the vehicle when it is determined that there is an abnormal vehicle operation, and limit a torque amount applied to the vehicle or notify a driver that the accelerator pedal is being operated when it is determined that the driver has misidentified the accelerator pedal as a brake pedal.

### CROSS REFERENCE TO RELATED APPLICATION

The present application claims, under 35 U.S.C. § 119(a), the benefit of Korean Patent Applications No. 10-2025-0020194, filed February 17, 2025, in the Korean Intellectual Property Office, the entire contents of which are incorporated herein by reference.

### BACKGROUND

### Technical Field

The present disclosure relates to vehicle driving system and, in particular, to vehicle driving systems comprising a controller configured to control a vehicle by determining whether there is abnormal vehicle operation and whether a driver has misidentified the accelerator pedal.

### Description of the Related Art

Multiple and recurring accidents have occurred, resulting in multiple casualties, due to drivers mistakenly recognizing the brake pedal as the accelerator pedal due to misjudgment. This causes the vehicle to suddenly accelerate. There is a need for technology to prevent serious accidents resulting from such misidentification.

The description provided above as a related art of the present disclosure is just for helping understand the background of the present disclosure and should not be construed as being included in the related art known by those skilled in the art.

### SUMMARY

An objective of the present disclosure is to provide a vehicle driving system that, even when a driver mistakenly recognizes the accelerator pedal as the brake pedal and continues to press the accelerator pedal, can determine the driver's misidentification in the vehicle and cut off the vehicle's driving force or induce the driver to release the pressure on the accelerator pedal by warning the driver that the accelerator pedal is being operated.

The technical subjects to implement in the present disclosure are not limited to the technical problems described above and other technical subjects that are not stated herein will be clearly understood by those skilled in the art from the following specifications.

According to an object of the present disclosure, a vehicle driving system is provided. The vehicle driving system may comprise an accelerator pedal configured to accelerate a vehicle, an accelerator pedal sensor configured to measure a degree of pressure applied to the accelerator pedal, and a computing device comprising a processor and a memory. The memory may be configured to store instructions that, when executed by the processor, are configured to cause the processor to determine whether there is an abnormal vehicle operation based on the degree of pressure on the accelerator pedal, determine whether the accelerator pedal is misidentified based on information about a road currently being driven on and a current speed of the vehicle when it is determined that there is an abnormal vehicle operation, and limit a torque amount applied to the vehicle or notify a driver that the accelerator pedal is being operated when it is determined that the driver has misidentified the accelerator pedal as a brake pedal.

According to an exemplary embodiment, the instructions, when executed by the processor, may be configured to cause the processor to determine whether there is an abnormal vehicle operation based on the degree of pressure on the accelerator pedal and a pressing time of the accelerator pedal, using the accelerator pedal sensor.

According to an exemplary embodiment, the instructions, when executed by the processor, may be configured to cause the processor to determine that there is an abnormal vehicle operation when the degree of pressure on the accelerator pedal and the pressing time of the accelerator pedal exceed a first threshold and a second threshold, respectively.

According to an exemplary embodiment, the vehicle driving system may comprise a navigation system.

According to an exemplary embodiment, the instructions, when executed by the processor, may be configured to cause the processor to receive road information via the navigation system.

According to an exemplary embodiment, the road information may comprise a type of a road currently being driven on and a speed limit of the road currently being driven on.

According to an exemplary embodiment, the instructions, when executed by the processor, may be configured to cause the processor to determine whether the accelerator pedal is misidentified by comparing the current speed of the vehicle with the speed limit of the road on which the vehicle is currently driving.

According to an exemplary embodiment, the instructions, when executed by the processor, may be configured to cause the processor to determine that the accelerator pedal has been misidentified when the road on which the vehicle is currently driving is a highway and a value obtained by dividing the current speed of the vehicle by the speed limit of the road currently being driven on exceeds a preset high-speed threshold.

According to an exemplary embodiment, the instructions, when executed by the processor, may be configured to cause the processor to determine that the accelerator pedal has been misidentified when the road on which the vehicle is currently driving is a regular road and a value obtained by dividing the current speed of the vehicle by the speed limit of the road currently being driven on exceeds a preset regular threshold.

According to an exemplary embodiment, the instructions, when executed by the processor, may be configured to cause the processor to, when the road on which the vehicle is currently driving is a highway and a value obtained by dividing the current speed of the vehicle by the speed limit of the road currently being driven on exceeds a preset high-speed threshold and is less than a preset restriction threshold, notify the driver that the accelerator pedal is being operated, limit the torque amount applied to the vehicle, request the driver to perform a specific action to accelerate the vehicle, and keep limiting the torque amount when the specific action is not input.

According to an exemplary embodiment, the instructions, when executed by the processor, may be configured to cause the processor to immediately limit the torque amount applied to the vehicle when a value obtained by dividing the current speed of the vehicle by the speed limit of the road currently being driven on is the preset restriction threshold or more.

According to an exemplary embodiment, when a distance from the vehicle to a preceding vehicle is within a predetermined range, the instructions, when executed by the processor, may be configured to cause the processor to decrease the preset high-speed threshold and the preset restriction threshold to determine whether the accelerator pedal is misidentified.

According to an exemplary embodiment, the instructions, when executed by the processor, may be configured to cause the processor to, when the road on which the vehicle is currently driving is a regular road and a value obtained by dividing the current speed of the vehicle by the speed limit of the road currently being driven on exceeds a regular threshold and is less than a preset restriction threshold, notify the driver that the accelerator pedal is being operated, limit the torque amount applied to the vehicle, request the driver to perform a specific action to accelerate the vehicle, and keep limiting the torque when the specific action is not input.

According to an exemplary embodiment, the instructions, when executed by the processor, may be configured to cause the processor to immediately limit the torque amount applied to the vehicle when a value obtained by dividing the current speed of the vehicle by the speed limit of the road currently being driven on is the preset restriction threshold or more.

According to an exemplary embodiment, when the road on which the vehicle is driving has two or fewer lanes, the instructions, when executed by the processor, may be configured to cause the processor to decrease the preset regular threshold and the preset restriction threshold to determine whether the accelerator pedal is misidentified.

According to an exemplary embodiment, when a distance from a vehicle's current location to an intersection is within a predetermined range, the instructions, when executed by the processor, may be configured to cause the processor to decrease the preset regular threshold and the preset restriction threshold to determine whether the accelerator pedal is misidentified.

According to an exemplary embodiment, when a distance from the vehicle to a preceding vehicle is within a predetermined range, the instructions, when executed by the processor, may be configured to cause the processor to decrease the preset regular threshold and the preset restriction threshold to determine whether the accelerator pedal is misidentified.

According to an object of the present disclosure, a method for controlling a vehicle driving system is provided. The method may comprise, using a computing device, determining whether there is an abnormal vehicle operation based on a degree of pressure applied to an accelerator pedal of the vehicle, the accelerator pedal being configured to accelerate the vehicle and the vehicle comprising an accelerator pedal configured to measure the degree of pressure applied to the accelerator pedal. The method may comprise, using the computing device, determining whether the accelerator pedal is misidentified based on information about a road currently being driven on and a current speed of the vehicle when it is determined that there is an abnormal vehicle operation and limiting a torque amount applied to the vehicle or notify a driver that the accelerator pedal is being operated when it is determined that the driver has misidentified the accelerator pedal as a brake pedal.

According to an exemplary embodiment, the method may comprise determining whether there is an abnormal vehicle operation based on the degree of pressure on the accelerator pedal and a pressing time of the accelerator pedal, using the accelerator pedal sensor.

According to an exemplary embodiment, the method may comprise determining that there is an abnormal vehicle operation when the degree of pressure on the accelerator pedal and the pressing time of the accelerator pedal exceed a first threshold and a second threshold, respectively.

According to an exemplary embodiment, the method may comprise receiving road information via a navigation system. The road information may comprise a type of a road currently being driven on and a speed limit of the road currently being driven on.

According to an exemplary embodiment, the method may comprise determining whether the accelerator pedal is misidentified by comparing the current speed of the vehicle with the speed limit of the road on which the vehicle is currently driving.

According to an object of the present disclosure, a non-transitory computer readable medium is provided. The non-transitory computer readable medium may comprise a processor and a memory. The memory may be configured to store instructions that, when executed by the processor, are configured to cause the processor to determine whether there is an abnormal vehicle operation based on a degree of pressure on an accelerator pedal of a vehicle, determine whether the accelerator pedal is misidentified based on information about a road currently being driven on and a current speed of the vehicle when it is determined that there is an abnormal vehicle operation, and limit a torque amount applied to the vehicle or notify a driver that the accelerator pedal is being operated when it is determined that the driver has misidentified the accelerator pedal as a brake pedal.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a block diagram of a vehicle driving system, according to an exemplary embodiment of the present disclosure; and

FIG. 2 illustrates a flowchart of a method for controlling a vehicle system, according to an exemplary embodiment of the present disclosure.

FIG. 3 illustrates a flowchart of a method for controlling a vehicle system, according to an exemplary embodiment of the present disclosure.

FIG. 4 illustrates an example architecture of a vehicle, according to an exemplary embodiment of the present disclosure.

FIG. 5 illustrates example elements of a computing device, according to an exemplary embodiment of the present disclosure.

### DETAILED DESCRIPTION

Hereinafter, the exemplary embodiment of the present disclosure will be described in detail. This exemplary embodiment is implemented based on the technical solution of the present disclosure, and shows a specific implementation method and a specific operation process, but the protection scope of the present disclosure is not limited to the exemplary embodiment below.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms "a," "an" and "the" are intended to include the plural forms as well, unless the context clearly indicates otherwise. These terms are merely intended to distinguish one component from another component, and the terms do not limit the nature, sequence or order of the constituent components. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, embodiments of the present disclosure will be described with reference to the accompanying drawings.

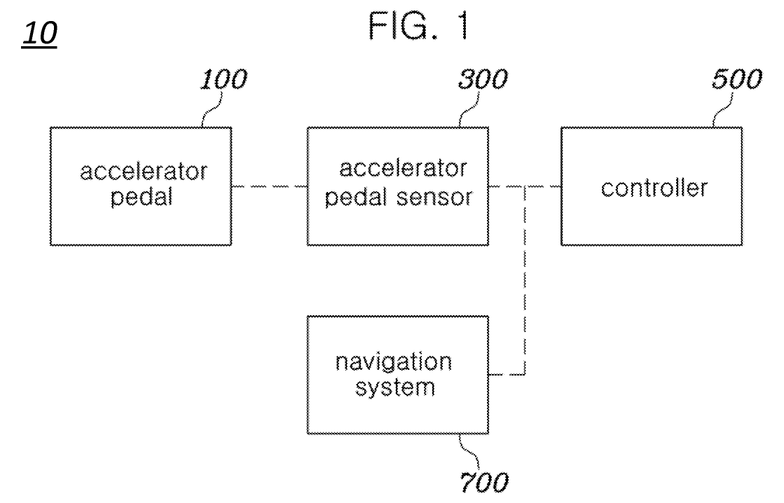

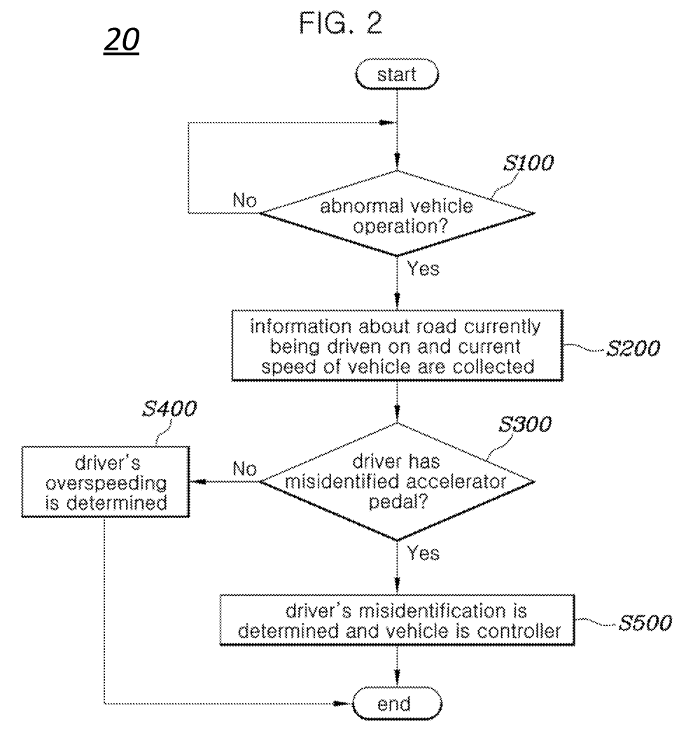

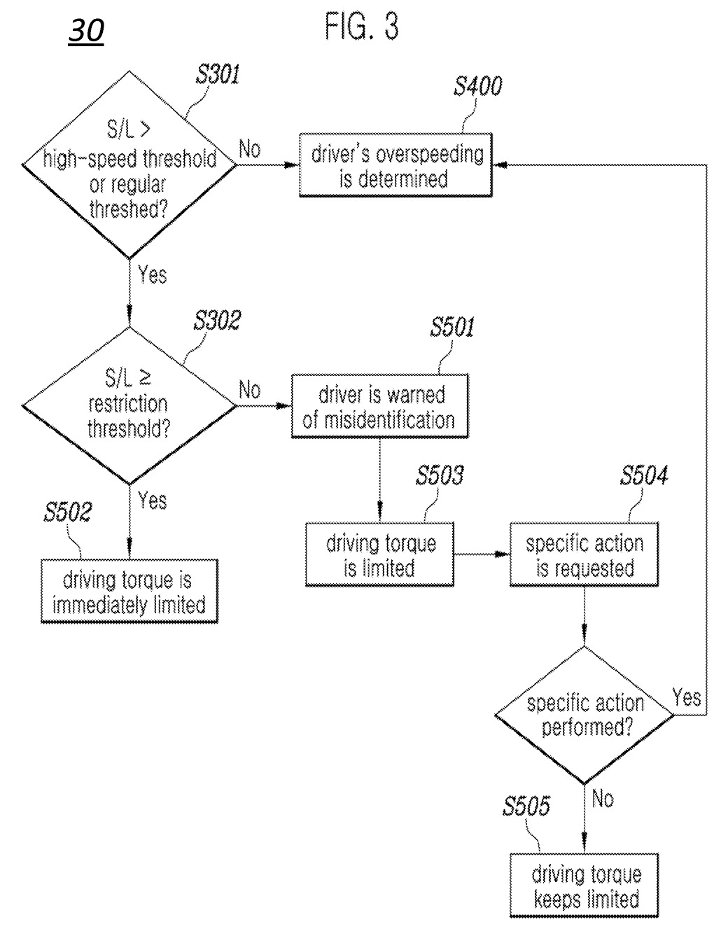

Referring now to FIGS. 1-3, a block diagram (FIG. 1) of a vehicle driving system and methods (method 20 of FIG. 2 and method 30 of FIG. 3) for controlling a vehicle system are illustratively depicted, in accordance with exemplary embodiments of the present disclosure.

Referring to FIG. 1 and FIG. 2, the vehicle driving system 10 may comprise an accelerator pedal 100 configured to accelerate a vehicle, an accelerator pedal sensor 300 configured to measure a depression amount of the accelerator pedal 100, and a controller 500 configured to determine whether the vehicle is being abnormally operated, determine whether a driver has misidentified the accelerator pedal 100, and control the vehicle.

In general, situations in which a driver operates the brake pedal may be typically represented by cases such as when a preceding vehicle decelerates, the vehicle approaches a stop sign, when a green light at an intersection ahead changes to a red light, and/or other suitable situations. Further, in situations in which a driver operates the brake pedal, the driver may be in a comfortable state if the distance to a preceding vehicle is large or the distance to an intersection ahead is large, whereas the driver may be in a tense state if the distance to a preceding vehicle is small or the distance to an intersection ahead is small.

When a driver is in a comfortable state, the driver usually decelerates gradually by pressing the brake pedal in multiple stages. In these situations, even when the driver misidentifies the accelerator pedal as the brake pedal, the likelihood of a major problem occurring is low because the degree of acceleration is low. However, when a driver is in a tense state, the driver may decelerate within a short time by forcefully pressing the brake pedal. In these situations, if the driver misidentifies the accelerator pedal as the brake pedal, acceleration of the vehicle may increase significantly, which may lead to a serious problem (e.g., a traffic collision).

According to an exemplary embodiment, the controller 500 may be configured to receive information about the amount of pressure applied to the accelerator pedal 100 by a driver through the accelerator pedal sensor 300. The controller 500 may be configured to determine (S100) whether there is an abnormal vehicle operation on the basis of the degree of pressure on the accelerator pedal 100 calculated on the basis of the amount of pressure. According to an exemplary embodiment, when the degree of pressure exceeds a normal range and is determined to be an abnormal vehicle operation, the system may be configured to proceed to the next step.

The controller 500 may be configured to collect information about the road on which the vehicle is currently driving and the current speed of the vehicle (S200). On the basis of this information, the system may be configured to determine whether the driver has misidentified the accelerator pedal 100 as the brake pedal (S300). Further, when determining that the driver has misidentified the accelerator pedal 100, the controller 500 may be configured to notify/warn the driver that the accelerator pedal 100 is currently being operated and/or may be configured to directly control the vehicle by immediately blocking or limiting a torque amount applied to the vehicle to prevent the vehicle's speed from increasing (S500).

According to an exemplary embodiment, the controller 500 may be configured to determine whether there is abnormal vehicle operation on the basis of the amount of pressure on the accelerator pedal 100 and the pressing time of the accelerator pedal 100 that are measured by the accelerator pedal sensor 300 (S100). According to an exemplary embodiment, the controller 500 may be configured to determine whether an abnormal vehicle operation has occurred when an amount of pressure on the accelerator pedal 100 and the pressing time of the accelerator pedal 100 exceed a first acceleration threshold and a second acceleration threshold, respectively.

For example, when the amount of pressure (X%) of the accelerator pedal 100 and the pressing time (Y) of the accelerator pedal 100 exceed a first acceleration threshold and a second acceleration threshold, which are predetermined values, respectively, the controller 500 may be configured to determine that an abnormal vehicle operation has occurred or is occurring.

For example, when the first acceleration threshold is set to 95%, the second acceleration threshold is set to 1 second, the amount of pressure on the accelerator pedal is 95% or more, and the pressing time is maintained for 1 second or more, the controller 500 may be configured to determine that an abnormal vehicle operation has occurred or is occurring.

According to an exemplary embodiment, when a driver stops pressing the accelerator pedal 100 or reduces the degree of pressure, even if abnormal vehicle operation is determined, it may be determined that the driver recognizes the misidentification of the accelerator pedal as the brake pedal or intentionally presses the accelerator pedal due to necessity, and thus the system may not proceed to the next step.

When abnormal vehicle operation is determined and the driver maintains an amount of pressure greater than the first acceleration threshold, the controller 500 may be configured to proceed to the next step and determine whether the driver has misidentified the accelerator pedal as the brake pedal (S300).

The controller 500 may be configured to collect road information to determine whether the driver has misidentified the accelerator pedal 100 (S200). The vehicle driving system 10 according to the present disclosure may further comprise a navigation system 700. A database (DB) of road information may be stored in the navigation system 700, and the database may be updated in real time through a server. The road information stored in the navigation system 700 may comprise information about the type of road on which the vehicle is currently driving and information about the speed limit of the road currently being driven on.

According to an exemplary embodiment, the controller may be configured to request road information from the navigation system and receive road information from the navigation system. In this case, the types of roads may comprise highways and regular roads, and the regular roads may comprise roads, which are not highways, and may comprise private roads that are not public roads. The private roads refer to roads used for access within residential complexes such as, e.g., apartment complexes or roads owned and managed by individuals or legal entities, such as schools. According to an exemplary embodiment, when there is no speed limit information for the private road on which the vehicle is currently driving, the controller 500 may be configured to set the speed limit to a set speed (e.g., 20 km/h and/or other suitable set speed) uniformly. For example, the speed limit on highways may be set in a variety of ways, such as 80 km/h and 110 km/h, and the speed limit on regular roads may be set in a variety of ways, such as 30 km/h, 40 km/h, 50 km/h, 60 km/h, and 80 km/h. Further, the vehicle driving system 10 according to the present disclosure may further comprise an intelligent speed assistance (ISA) camera, and when the ISA camera is included, it may be possible to determine the speed limit of the road currently being driven on through the ISA camera.

Referring to FIG. 3, the controller 500 may be configured to determine whether the driver has misidentified the accelerator pedal by comparing the current speed of the vehicle and the speed limit of the road currently being driven on. According to an exemplary embodiment, the controller 500 may be configured to determine whether the driver has misidentified the accelerator pedal (S301) on the basis of the value (S/L) obtained by dividing the current speed (S) of the vehicle by the speed limit (L) of the road currently being driven on.

When the road currently being driven on is a highway, the value S/L obtained by dividing the current speed S by the speed limit L of the road currently being driven on may be compared with a preset high-speed threshold, and, when the value S/L obtained by dividing the current speed S by the speed limit L of the road currently being driven on exceeds the preset high-speed threshold, it may be determined that the driver has misidentified the accelerator pedal 300.

When the road currently being driven on is a regular road, the value S/L obtained by dividing the current speed S by the speed limit L of the road currently being driven on may be compared with a preset regular threshold, and, when the value S/L obtained by dividing the current speed S by the speed limit L of the road currently being driven on exceeds the preset regular threshold, it may be determined that the driver has misidentified the accelerator pedal.

The reason for categorizing the value S/L obtained by dividing the current speed S by the speed limit L of the road currently being driven on into highway and regular road categories and applying different thresholds (e.g., high-speed threshold, regular threshold) is because, generally, the driving speed on highways is faster than on regular roads and, while there are junctions, there are no intersections like on those regular roads, so the probability of the driver intentionally accelerating is higher on highways than on regular roads. Therefore, the controller 500 may be configured to determine whether the driver has misidentified the accelerator pedal by applying the high-speed threshold or the regular threshold on the basis of the type of road on which the vehicle is currently driving.

For example, the high-speed threshold may be set to, e.g., 1.6 and the regular threshold may be set to, e.g., 1.5, thereby increasing the sensitivity of the determination of the driver's misidentification of the accelerator pedal when the vehicle is driving on a regular road compared to when it is driving on a highway. Accordingly, it is possible to further enhance the stability of the vehicle driving system according to the present disclosure.

The values of the high-speed threshold and the regular threshold described above are only examples, and the high-speed threshold may be set lower than the regular threshold or may be set the same.

According to an exemplary embodiment, when the controller 500 determines that the driver has misidentified the accelerator pedal 100 as the brake pedal, the controller 500 may be configured to warn the driver that the accelerator pedal is currently being operated (S501), or the controller 500 may be configured to immediately limit the torque applied to the vehicle (S502). This is for performing more detailed vehicle control by comparing the value S/L obtained by dividing the current driving speed S by the speed limit L of the road currently being driven on with the preset restriction threshold, even though the value S/L obtained by dividing the current driving speed S by the speed limit L of the road currently being driven on exceeds the high-speed threshold or the regular threshold.

When the value S/L obtained by dividing the current driving speed S by the speed limit L of the road currently being driven on is less than the preset restriction threshold, the controller 500 may be configured to warn the driver that the accelerator pedal is being operated (S501). Further, when the amount of pressure on the accelerator pedal is decreased after a certain period of time, the torque applied to the vehicle may be limited (S503). According to an exemplary embodiment, the controller May be configured to request the driver to perform a specific action to determine whether the driver's current acceleration is intentional (S504).

For example, if the controller (500) issues a warning about misoperation of the accelerator pedal through an audio video navigation (AVN) interface or speakers in the vehicle and the amount of pressure on the accelerator pedal does not decrease after a certain period of time, the controller 500 may be configured to limit the torque applied to the vehicle and also request through the AVN interface or speakers in the vehicle that the driver stop pressing the accelerator pedal 300 for more than a set length of time (e.g., 1 second or other suitable length of time) and then press the accelerator pedal 300 again if the user wants to accelerate. If a specific action performed by the driver is input to the controller, it may be determined as the driver's intentional overspeeding (S400), and the vehicle driving system may be configured to be controlled not to start for a certain period/length of time. On the other hand, if the driver does not perform a specific action, the torque limit may be maintained (S505).

As described above, by requesting a driver to perform a specific action, unintended acceleration of the driver may be prevented, or it may be made clear that the driver intends to accelerate, thereby increasing the stability of vehicle operation.

Meanwhile, the restriction threshold may be set differently for highways and regular roads, or it may be set the same for both.

On the other hand, when the value S/L obtained by dividing the current driving speed S by the speed limit L of the road currently being driven on is equal to or more than the restriction threshold, the controller 500 may be configured to immediately limit the torque applied to the vehicle (S502). In this situation, since there is a high probability that the driver has misidentified the accelerator pedal 100 as the brake pedal and is pressing the accelerator pedal very hard, the controller 500 may be configured to immediately limit the torque applied to the vehicle (S502), reduce the vehicle's speed, and issue an instruction/notification to guide the driver to lift their foot off the accelerator pedal 300.

Meanwhile, regular roads may have a much wider variety of situations than highways. For example, there may be narrow alleyways with very small road widths, one-way roads where vehicles can only drive in one direction, or roads where vehicles can drive in both directions but without a center line. Further, unlike highways, regular roads may have pedestrians in the vicinity, and there may be intersections with crosswalks where pedestrians can pass. In order to reflect such circumstances, in specific situations, the preset regular threshold and the preset restriction threshold may be decreased to increase the sensitivity to determination of the driver's misidentification of the accelerator pedal, thereby further enhancing the stability of the vehicle driving system 10 according to an exemplary embodiment of the present disclosure. For example, when the road on which the vehicle is driving has two or fewer lanes, the preset regular threshold and the preset restriction threshold may be decreased to determine whether the accelerator pedal has been misidentified.

Further, when the distance from the vehicle's current location to an intersection is within a predetermined range, the preset regular threshold and the preset restriction threshold may be decreased to determine whether the accelerator pedal has been misidentified.

Further, when the distance from the vehicle to a preceding vehicle is within a predetermined range, the preset regular threshold and the preset restriction threshold may be decreased to determine whether the accelerator pedal has been misidentified. This is for preventing accidents that may occur when the preceding vehicle makes a sudden stop and causes the driver to panic or lose focus, which results in misidentification of the accelerator pedal as the brake pedal. This situation may also occur on highways, so it may be applied when the vehicle is driving on highways as well.

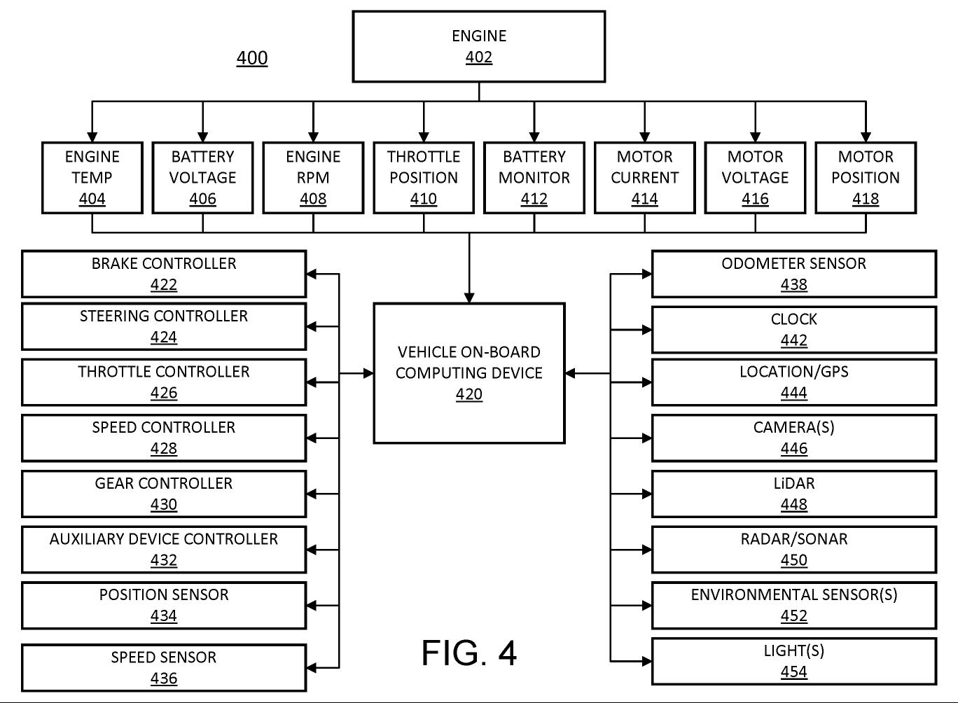

Referring now to FIG. 4, an example vehicle system architecture 400 for a vehicle is provided, in accordance with an exemplary embodiment of the present disclosure. The following discussion of vehicle system architecture 400 is sufficient for understanding one or more components of the vehicle described herein (including, e.g., vehicle system 10).

As shown in FIG. 4, the vehicle system architecture 400 may comprise an engine, motor or propulsive device 402 and various sensors 404-418 for measuring various parameters of the vehicle system architecture 400, such as, but not limited to, those of the vehicle snapshot described above. In gas-powered or hybrid vehicles having a fuel-powered engine, the sensors 404-418 may comprise, for example, an engine temperature sensor 404, a battery voltage sensor 406, an engine Rotations Per Minute (RPM) sensor 408, and/or a throttle position sensor 410. If the vehicle is an electric or hybrid vehicle, then the vehicle may comprise an electric motor, and accordingly may comprise sensors such as a battery monitoring system 412 (to measure current, voltage and/or temperature of the battery), motor current 414 and voltage 416 sensors, and motor position sensors such as resolvers and encoders 418.

Operational parameter sensors that are common to both types of vehicles may comprise, for example: a position sensor 434 such as an accelerometer, gyroscope and/or inertial measurement unit; a speed sensor 436; and/or an odometer sensor 438. The vehicle system architecture 400 also may comprise a clock 442 that the system uses to determine vehicle time and/or date during operation. The clock 442 may be encoded into the vehicle on-board computing device 420, it may be a separate device, or multiple clocks may be available.

The vehicle system architecture 400 may comprise various sensors that operate to gather information about the environment in which the vehicle is traveling. These sensors may comprise, for example: a location sensor 444 (for example, a Global Positioning System (GPS) device); object detection sensors such as one or more cameras 446; a LiDAR sensor system 448; and/or a radar and/or a sonar system 450. The sensors may comprise environmental sensors 452 such as, e.g., a humidity sensor, a precipitation sensor, a light sensor, and/or ambient temperature sensor. The object detection sensors may be configured to enable the vehicle system architecture 400 to detect objects that are within a given distance range of the vehicle in any direction, while the environmental sensors 452 may be configured to collect data about environmental conditions within the vehicle's area of travel. According to an exemplary embodiment, the vehicle system architecture 400 may comprise one or more lights 454 (e.g., headlights, flood lights, flashlights, etc.).

During operations, information may be communicated from the sensors to an on-board computing device 420. The on-board computing device 420 may be configured to analyze the data captured by the sensors and/or data received from data providers and may be configured to optionally control operations of the vehicle and/or vehicle system 10 based on results of the analysis. For example, the on-board computing device 420 may be configured to control: braking via a brake controller 422; direction via a steering controller 424; speed and acceleration via a throttle controller 426 (in a gas-powered vehicle) or a motor speed controller 428 (such as a current level controller in an electric vehicle); a differential gear controller 430 (in vehicles with transmissions); and/or other controllers. The brake controller 422 may comprise a pedal effort sensor, pedal effort sensor, and/or simulator temperature sensor, as described herein.

Geographic location information may be communicated from the location sensor 444 to the on-board computing device 420, which may then access a map of the environment that corresponds to the location information to determine known fixed features of the environment such as streets, buildings, stop signs and/or stop/go signals. Captured images from the cameras 446 and/or object detection information captured from sensors such as LiDAR 448 may be communicated from those sensors to the on-board computing device 420. The object detection information and/or captured images may be processed by the on-board computing device 420 to detect objects in proximity to the vehicle. Any known or to be known technique for making an object detection based on sensor data and/or captured images may be used in the embodiments disclosed in this document.

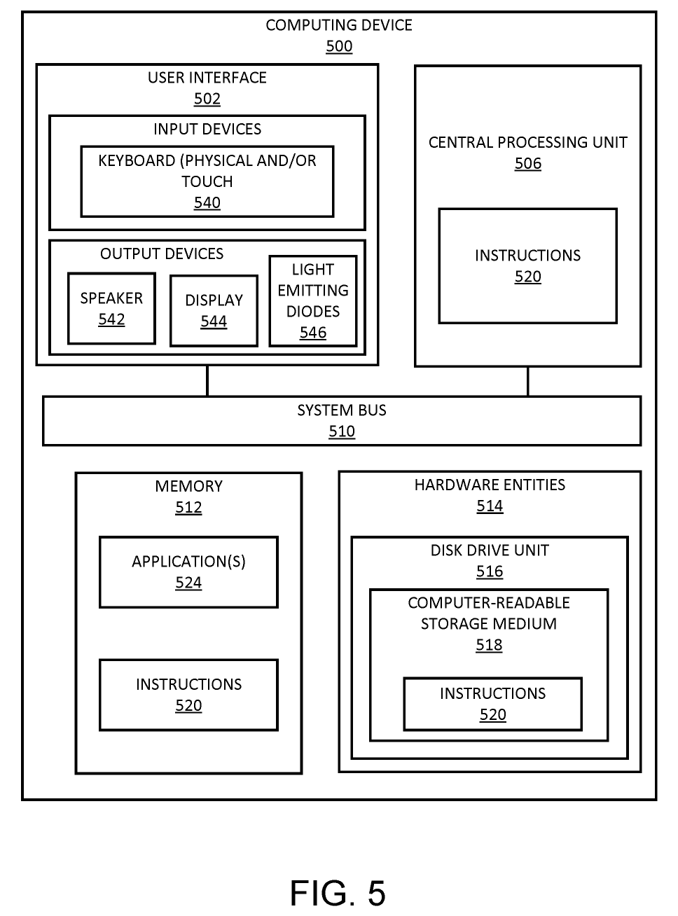

Referring now to FIG. 5, an illustration of an example architecture for a computing device 500 is provided. According to an exemplary embodiment, one or more functions of the present disclosure may be implemented by a computing device such as, e.g., computing device 500 or a computing device similar to computing device 500. Computing device 500 may be a quantum computer, a classical computer, and/or have one or more components configured to perform one or more quantum and/or classical computing functions. Computing device 420 may be an example of computing device 500 and/or may comprise one or more components of computing device 500.

The hardware architecture of FIG. 5 represents one example implementation of a representative computing device configured to implement at least a portion of the systems/devices (e.g., vehicle system 10) and method(s)/control logic(s) (e.g., method 20, method 30) described herein.

Some or all components of the computing device 500 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 5, the computing device 500 may comprise a user interface 502 (e.g., a graphical user interface), a Central Processing Unit (“CPU”) 506, a system bus 510, a memory 512 connected to and accessible by other portions of computing device 500 through system bus 510, and hardware entities 514 connected to system bus 510. The user interface may comprise input devices and output devices, which may be configured to facilitate user-software interactions for controlling operations of the computing device 500. The input devices may comprise, but are not limited to, a physical and/or touch keyboard 540. The input devices may be connected to the computing device 500 via a wired or wireless connection (e.g., a Bluetooth® connection). The output devices may comprise, but are not limited to, a speaker 542, a display 544, and/or light emitting diodes 546.

At least some of the hardware entities 514 may be configured to perform actions involving access to and use of memory 512, which may be a Random Access Memory (RAM), a disk driver and/or a Compact Disc Read Only Memory (CD-ROM), among other suitable memory types. Hardware entities 514 may comprise a disk drive unit 516 comprising a computer-readable storage medium 518 on which may be stored one or more sets of instructions 520 (e.g., programming instructions such as, but not limited to, software code) configured to implement one or more of the methodologies, procedures, or functions described herein. The instructions 520 may also reside, completely or at least partially, within the memory 512 and/or within the CPU 506 during execution thereof by the computing device 500.

The memory 512 and the CPU 506 may also constitute machine-readable media. The term “machine-readable media”, as used here, refers to a single medium or multiple media (e.g., a centralized or distributed database, and/or associated caches and servers) that store the one or more sets of instructions 520. The term “machine-readable media”, as used here, also refers to any medium that is capable of storing, encoding, or carrying a set of instructions 520 for execution by the computing device 500 and that cause the computing device 500 to perform any one or more of the methodologies of the present disclosure. According to various embodiments, one or more computer applications 524 may be stored on the memory 512.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A vehicle driving system, comprising:
a) an accelerator pedal configured to accelerate a vehicle;
b) an accelerator pedal sensor configured to measure a degree of pressure applied to the accelerator pedal; and
c) a computing device comprising a processor and a memory, wherein the memory is configured to store instructions that, when executed by the processor, are configured to cause the processor to:
i) determine whether there is an abnormal vehicle operation based on the degree of pressure on the accelerator pedal;
ii) determine whether the accelerator pedal is misidentified based on information about a road currently being driven on and a current speed of the vehicle when it is determined that there is an abnormal vehicle operation; and
iii) limit a torque amount applied to the vehicle or notify a driver that the accelerator pedal is being operated when it is determined that the driver has misidentified the accelerator pedal as a brake pedal.

2. The vehicle driving system of claim 1, wherein the determining whether there is an abnormal vehicle operation is based on the degree of pressure on the accelerator pedal and a pressing time of the accelerator pedal, using the accelerator pedal sensor.

3. The vehicle driving system of claim 2, wherein it is determined that there is an abnormal vehicle operation when the degree of pressure on the accelerator pedal and the pressing time of the accelerator pedal exceed a first threshold and a second threshold, respectively.

4. The vehicle driving system of claim 1, further comprising a navigation system configured to receive road information,
wherein the road information comprises a type of a road currently being driven on and a speed limit of the road currently being driven on.

5. The vehicle driving system of claim 4, wherein the determining whether the accelerator pedal is misidentified comprises comparing the current speed of the vehicle with the speed limit of the road on which the vehicle is currently driving.

6. The vehicle driving system of claim 5, wherein it is determined that the accelerator pedal has been misidentified when the road on which the vehicle is currently driving is a highway and a value obtained by dividing the current speed of the vehicle by the speed limit of the road currently being driven on exceeds a preset high-speed threshold.

7. The vehicle driving system of claim 5, wherein it is determined that the accelerator pedal has been misidentified when the road on which the vehicle is currently driving is a regular road and a value obtained by dividing the current speed of the vehicle by the speed limit of the road currently being driven on exceeds a preset regular threshold.

8. The vehicle driving system of claim 5, wherein the computing device is configured to:
when the road on which the vehicle is currently driving is a highway and a value obtained by dividing the current speed of the vehicle by the speed limit of the road currently being driven on exceeds a preset high-speed threshold and is less than a preset restriction threshold, notify the driver that the accelerator pedal is being operated, limit the torque amount applied to the vehicle, request the driver to perform a specific action to accelerate the vehicle, and keep limiting the torque amount when the specific action is not input.

9. The vehicle driving system of claim 8, wherein the computing device is configured to immediately limit the torque amount applied to the vehicle when a value obtained by dividing the current speed of the vehicle by the speed limit of the road currently being driven on is the preset restriction threshold or more.

10. The vehicle driving system of claim 8, wherein, when a distance from the vehicle to a preceding vehicle is within a predetermined range, the computing device is configured to decrease the preset high-speed threshold and the preset restriction threshold to determine whether the accelerator pedal is misidentified.

11. A vehicle comprising the system of claim 1.

12. The vehicle driving system of claim 1, wherein the computing device is further configured to, when the road on which the vehicle is currently driving is a regular road and a value obtained by dividing the current speed of the vehicle by the speed limit of the road currently being driven on exceeds a regular threshold and is less than a preset restriction threshold;
notify the driver that the accelerator pedal is being operated;
limit the torque amount applied to the vehicle;
request the driver to perform a specific action to accelerate the vehicle; and
keep limiting the torque when the specific action is not input.

13. The vehicle driving system of claim 12, wherein the computing device is further configured to immediately limit the torque amount applied to the vehicle when a value obtained by dividing the current speed of the vehicle by the speed limit of the road currently being driven on is the preset restriction threshold or more.

14. The vehicle driving system of claim 12, when the road on which the vehicle is driving has two or fewer lanes, the computing device is further configured to decrease the preset regular threshold and the preset restriction threshold to determine whether the accelerator pedal is misidentified.

15. The vehicle driving system of claim 12, wherein, when a distance from a vehicle's current location to an intersection is within a predetermined range, the computing device is further configured to decrease the preset regular threshold and the preset restriction threshold to determine whether the accelerator pedal is misidentified.

16. The vehicle driving system of claim 12, wherein, when a distance from the vehicle to a preceding vehicle is within a predetermined range, the instructions, when executed by the processor, are further configured to cause the processor to decrease the preset regular threshold and the preset restriction threshold to determine whether the accelerator pedal is misidentified.

17. A method for controlling a vehicle driving system, comprising:
using a computing device:
determining whether there is an abnormal vehicle operation based on a degree of pressure applied to an accelerator pedal of the vehicle,
wherein:
the accelerator pedal is configured to accelerate the vehicle, and
the vehicle comprises an accelerator pedal configured to measure the degree of pressure applied to the accelerator pedal;
determining whether the accelerator pedal is misidentified based on information about a road currently being driven on and a current speed of the vehicle when it is determined that there is an abnormal vehicle operation; and
limiting a torque amount applied to the vehicle or notify a driver that the accelerator pedal is being operated when it is determined that the driver has misidentified the accelerator pedal as a brake pedal.

18. The method of claim 17, further comprising:
determining whether there is an abnormal vehicle operation based on the degree of pressure on the accelerator pedal and a pressing time of the accelerator pedal, using the accelerator pedal sensor; and
determining that there is an abnormal vehicle operation when the degree of pressure on the accelerator pedal and the pressing time of the accelerator pedal exceed a first threshold and a second threshold, respectively.

19. The method of claim 17, further comprising:
receiving road information via a navigation system,
wherein the road information comprises a type of a road currently being driven on and a speed limit of the road currently being driven on; and
determining whether the accelerator pedal is misidentified by comparing the current speed of the vehicle with the speed limit of the road on which the vehicle is currently driving.

20. A non-transitory computer readable medium, comprising:
a processor and a memory, wherein the memory is configured to store instructions that, when executed by the processor, are configured to cause the processor to:
i) determine whether there is an abnormal vehicle operation based on a degree of pressure on an accelerator pedal of a vehicle;
ii) determine whether the accelerator pedal is misidentified based on information about a road currently being driven on and a current speed of the vehicle when it is determined that there is an abnormal vehicle operation; and
iii) limit a torque amount applied to the vehicle or notify a driver that the accelerator pedal is being operated when it is determined that the driver has misidentified the accelerator pedal as a brake pedal.
